(19) United States
(12) Patent Application Publication
(10) Pub. No.: US 2010/0253490 A1
(43) Pub. Date: Oct. 7, 2010

(54) ANTI-THEFT SYSTEM AND ANTI-THEFT CONTROL METHOD

(75) Inventors: Naoki Sakai, Kobe (JP); Ryuuji Nishimura, Kobe (JP); Kyohhei Morita, Kobe (JP); Kazumasa Kameda, Kobe (JP); Takahiro Koizumi, Kobe (JP); Tomohiko Nukano, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi, Hyogo (JP)

(21) Appl. No.: 12/734,999

(22) PCT Filed: Nov. 28, 2008
(86) PCT No.: PCT/JP2008/071718

§ 371 Date: Jun. 9, 2010

(30) Foreign Application Priority Data
Dec. 14, 2007 (JP) 2007-324026

(51) Int. Cl. B60R 25/10

(52) U.S. Cl. 340/426.1

(57) ABSTRACT

An anti-theft system of a vehicle includes multiple speakers 1, 2, 3 and 4 that detect an impact applied to the vehicle; and a security ECU 10 that executes a detection unit identification process for identifying a speaker that detects the impact first on the basis of values of signals from multiple speakers 1, 2; 3 and 4; an impact location estimation process for estimating that the impact is applied to a window glass when a value of a signal from the identified speaker is greater than or equal to a predetermined threshold value, and estimating that the impact is applied to a vehicle body when the value of the signal from the identified speaker is less than or equal to the predetermined threshold value; and an impact location identification process for estimating a distance between the estimated detection unit and a generation source of the impact by a correction coefficient for a case that the estimated impact location is the window glass when the estimated impact location is the window glass, estimating the distance between the estimated detection unit and the generation source of the impact by a correction coefficient for a case that the estimated impact location is the vehicle body when the estimated impact location is the vehicle body, and identifying the impact location from the window glass, the vehicle body, and other locations on the basis of the estimated distance.

### TECHNICAL FIELD

The present invention relates to an anti-theft system and an anti-theft control method for preventing a vehicular theft. Especially it relates to techniques to identify a location of an impact applied to a vehicle by using a plurality of sound input units.

### BACKGROUND ART

There has been conventionally known of techniques to detect vibration of a vehicle by using a speaker for a car audio mounted to the vehicle (For example, see Patent References 1 and 2).

A back electromotive force is generated by vibration of a voice coil caused by a vehicle vibration in a speaker device which makes sound by providing output signals of an audio amplifier circuit to the voice coil located in a magnetic field. The vehicle vibration can be detected by detecting the back electromotive force.

[Patent Reference 1] Japanese Patent Application Publication No. 2005-262944

[Patent Reference 2] Japanese Patent Application Publication No. 2007-137157

### DISCLOSURE OF THE INVENTION

### Problems to be Solved by the Invention

However, there are possibilities that a false alarm is sounded by detecting vibration and noise other than vibration caused by a theft or a car break-in when a vibration detection using a speaker is used to prevent a vehicular theft or a car break-in.

Especially, as a theft breaks into a vehicle by generally smashing car windows for a vehicular theft or a car break-in, it is necessary to distinguish between a breaking of a glass, and vibration and noise around the vehicle.

The present invention is made in views of above circumstances, and the aim of the present invention is to provide an anti-theft system and an anti-theft control method capable of determining an impact which is applied to a vehicle with good accuracy and preventing a vehicular theft.

### Means for Solving the Problems

To achieve above aims, the present invention is an anti-theft system including a plurality of detection units that detect an impact applied to the vehicle; and a control device that executes: a detection unit identification process for identifying a detection unit that detects the impact first on the basis of values of signals from the plurality of detection units; an impact location estimation process for estimating that the impact is applied to a window glass when a value of a signal from the identified detection unit is greater than or equal to a predetermined threshold value, and estimating that the impact is applied to a vehicle body when the value of the signal from the identified detection unit is less than or equal to the predetermined threshold value; and an impact location identification process for estimating a distance between the estimated detection unit and a generation source of the impact by a correction coefficient for a case that the estimated impact location is the window glass when the estimated impact location is the window glass, estimating the distance between the estimated detection unit and the generation source of the impact by a correction coefficient for a case that the estimated impact location is the vehicle body when the estimated impact location is the vehicle body, and identifying an impact location from the window glass, the vehicle body, and other locations on the basis of the estimated distance.

It is possible to determine a part of vehicle to which the impact is applied with good accuracy and prevent a vehicular theft.

In the above anti-theft system, it is preferable that the control device executes a thunder determination process for determining whether the impact applied to the vehicle is caused by a thunder on the basis of the value of the signal from the detection unit.

Therefore, it is possible to determine whether the impact applied to the vehicle is a thunder with good accuracy.

In the above anti-theft system, it is preferable that the detection unit is one of a speaker, a radio wave sensor, a vibration sensor, and a sound sensor mounted in the vehicle.

In the above anti-theft system, it is preferable that the detection unit is one of a speaker, a radio wave sensor, a vibration sensor, and a sound sensor mounted in the vehicle.

Therefore, it is possible to prevent a vehicular theft by outputting an alarm sound when an impact location is a car window, or a vehicle body.

In the above anti-theft system, it is preferable that the impact location identification process is for defining a distance between the detection unit that detects the impact first among the plurality of detection units that detect the impact applied to the vehicle and the generation source of the impact as a standard distance, and calculating how far away distances between other detection units and the generation source are from the standard distance on the basis of a difference between input times of signals representing the impact from the detection unit that detects the impact first and other detection units.

Therefore, it is possible to calculate distances between other detection units and a generation source of an impact with good accuracy.

In the above anti-theft system, it is preferable that the impact location identification process is for identifying the location of the generation source of the impact by converting distances between the plurality of the detection unit that detect the impact applied to the vehicle and the generation source of the impact to distances on a given plane.

Therefore, it is possible to calculate a location of a generation source of an impact easily by calculating distances between the plurality of detection units and the generation source of the impact by converting them to distances on the given plane.

In the above anti-theft system, it is preferable that the impact location identification process is for identifying an intersection of circles of which radii are distances between at least three of the detection units and the generation source of the impact on the given plane as the generation source of the impact on the given plane.

Therefore, it is possible to identify the generation source of an impact by easy calculation.

The present invention is an anti-theft control method that executes a detection unit identification step that identifies a detection unit that detects an impact first on the basis of values of signals from a plurality of detection unites that detects the impact applied to the vehicle; an impact location estimation step that estimates that the impact is applied to a window glass when a value of a signal from the identified detection unit in the detection unit identification step is greater than or equal to a predetermined threshold value, and estimates that the impact is applied to a vehicle body when the value of the signal from the identified detection unit is less than or equal to the predetermined threshold value; an impact location identification step that estimates a distance between the estimated detection unit and a generation source of the impact by a correction coefficient for a case that the estimated impact location is the window glass when the estimated impact location in the impact location estimation step is the window glass, estimates the distance between the estimated detection unit and the generation source of the impact by a correction coefficient for a case that the estimated impact location is the vehicle body when the estimated impact location is the vehicle body, and identifies the impact location from the window glass, the vehicle body, and other locations on the basis of the estimated distance.

### EFFECTS OF THE INVENTION

According to the present invention, it is possible to detect an impact applied to a vehicle with good accuracy, and prevent a vehicular theft.

### BRIEF DESCRIPTION OF DRAWINGS

FIG. 1 is a diagram illustrating a composition of an embodiment in accordance with an anti-theft apparatus;

FIG. 2 is a diagram illustrating locations of speakers mounted to a vehicle;

FIG. 3 is a diagram illustrating a composition of a security ECU;

FIG. 4 is a diagram illustrating a hardware structure of a microcomputer;

FIG. 5A illustrates signal waveforms of back electromotive force detected by each speaker when an impact is applied to the driver's window with a jig, FIG. 5B is an enlarged view of a main part of FIG. 5A, FIG. 5C illustrates signal waveforms of back electromotive force detected by each speaker when an impact is applied to the driver's window by hand, and FIG. 5D is an enlarged view of a main part of FIG. 5C;

FIG. 6 is a diagram for explaining a method for identifying a location where an impact is applied;

FIG. 7 is a diagram for explaining a method for calculating a location where an impact is applied;

FIG. 8 is a flowchart illustrating a procedure of a microcomputer; and

FIG. 9 is a diagram illustrating another composition of the anti-theft apparatus.

### BEST MODES FOR CARRYING OUT THE INVENTION

A description will now be given, with reference to accompanied drawings, of best embodiment of the present invention.

### Embodiment

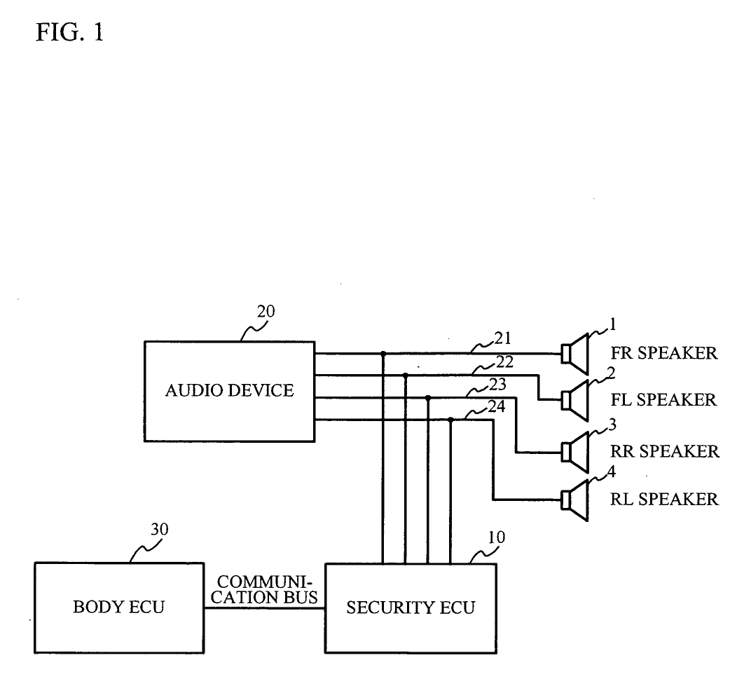

Referring to FIG. 1, a description will be given of a composition of the present embodiment.

As illustrated in FIG. 1, an anti-theft apparatus in accordance with the present embodiment has a composition where a security ECU 10 is coupled to a signal line which couples an audio device 20 to multiple speakers 1, 2, 3 and 4 that are output units of the audio device. The security ECU 10 is coupled to a body ECU 30 by a communication bus, and communicates with the body ECU 30 with a protocol such as CAN (Controller Area Network).

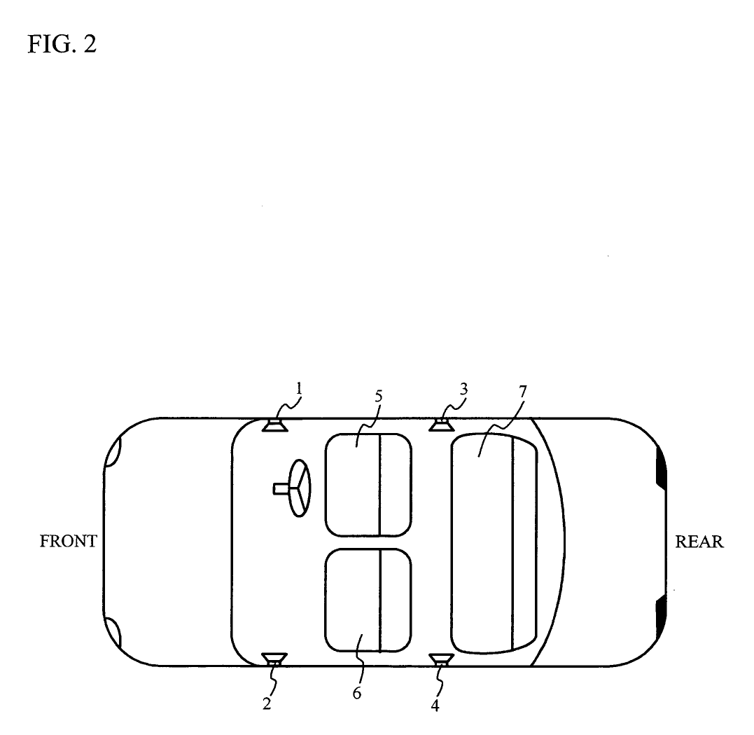

The multiple speakers (sound input units) are located in different places in the vehicle. It is desirable to spread these speakers to back and front and left and right. In the present embodiment, as illustrated in FIG. 2, a front speaker FR1 on a driver's seat 5 side that is located on a door to a driver's seat 5 and faces to a vehicle interior, a front speaker FL2 on the passenger seat 6 side that is located on a door to a passenger's seat 6 and faces to the vehicle interior, a rear speaker RR3 on the driver's seat 5 side that is located on a door to a rear seat 7 and faces to the vehicle interior, and a rear speaker RL 4 on the passenger's seat 6 side that is located on a door to the rear seat 7 and faces to the vehicle interior are provided. Hereinafter, the front speaker FR1 on the driver's seat 5 side is referenced as a speaker 1, the front speaker FL2 on the passenger seat 6 side is referenced as a speaker 2, the rear speaker RR3 on the driver's seat 5 side is referenced as a speaker 3, and the rear speaker RL 4 on the passenger's seat 6 side is referenced as a speaker 4. Speakers mounted to the vehicle are not limited to these speakers. It is possible to provide a speaker in a front panel part of the vehicle, or a rear side of the rear seat 7, for example.

The audio device 20 processes signals input from multiple audio sources such as a DVD player, a CD player, and a tuner, and generates audible signals to be played by the multiple speakers, and provide audible signals to speakers 1, 2, 3 and 4.

The body ECU 30 is a control device that performs controls to lock/unlock doors and put power windows up/down.

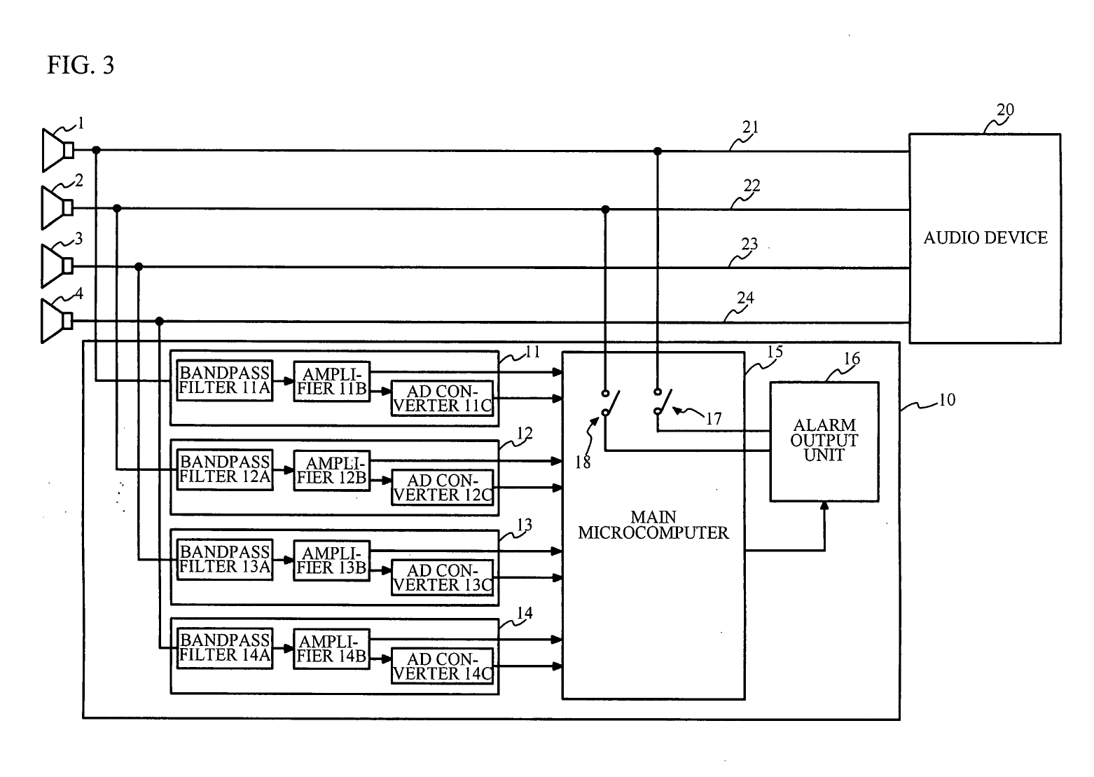

The security ECU 10 detects an intrusion into a vehicle interior by illegal operation such as breaking of window, illegal unlock, and operation of an ignition switch, and sounds an alarm. A composition of the security ECU 10 is illustrated in FIG. 3.

As illustrated in FIG. 3, the security ECU 10 is provided with signal processing units 11, 12, 13 and 14, a main microcomputer 15, and an alarm output unit 16.

The signal processing units 11, 12, 13 and 14 are respectively provided in accordance with the speakers 1, 2, 3 and 4 mounted to the vehicle. The signal processing unit 11 is coupled to a signal line 21 which couples the audio device 20 with the speaker 1, the signal processing unit 12 is coupled to a signal line 22 which couples the audio device 20 to the speaker 2, the signal processing unit 13 is couple to a signal line 23 which couples the audio device 20 with the speaker 3, and the signal processing unit 14 is coupled to a signal line 24 which couples the audio device 20 with the speaker 4. Signal processing units 11, 12, 13 and 14 have a same composition: Therefore, a description will be given of the signal processing unit 11 on behalf of other signal processing units.

The signal processing unit 11 includes a bandpass filter 11A, an amplifier 11B, and AD converter 11C, receives signals of back electromotive force generated in the speaker 1, and executes filtering, and amplification. Amplified signals that are AD-converted by the AD converter 11C and amplified signals that are not AD-converted are output from the signal processing unit 11 to the main microcomputer 15.

The main microcomputer 15 receives signals processed by signal processing units 11, 12, 13 and 14, determines whether an impact is applied to the vehicle to be monitored based on these signals, and determines the impact location when the impact is applied. These determination methods will be described later. When it is determined that the vehicle is in danger of a theft or a car break-in based on the determination result, a signal is output to the alarm output unit 16, and an alarm sound is output. In the present embodiment, the alarm sound that the alarm output unit 16 generates is output from speakers 1 and 2. When the alarm sound is output, the main microcomputer 15 turns on switches 17 and 18, and connects the alarm output unit 16 and signal lines 21 and 22.

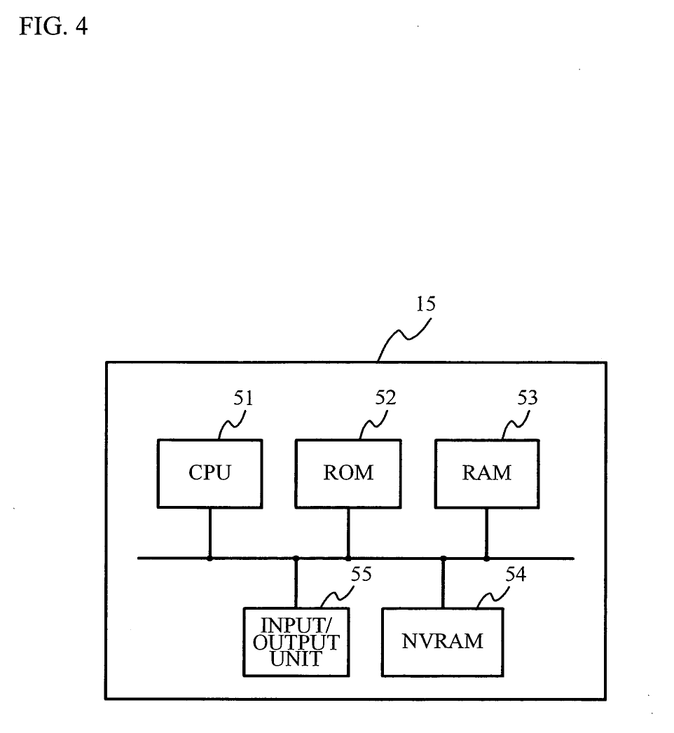

FIG. 4 illustrates a hardware structure of the main microcomputer 15.

The main microcomputer 15 includes a CPU 51, a ROM 52, a RAM 53, an NVRAM (Non Volatile RAM) 54, an input/output unit 55 and the like. The CPU 51 reads programs stored in the ROM 52, and executes calculations according to programs. As programs stored in the ROM 52 are read by the CPU 51, it is determined whether the vehicle is in danger of a theft or a car break-in. These determination procedures will be described in detail later with reference to a flowchart. Data such as calculation results are written in the RAM 53. Data that are included in data written in the RAM 53 and are necessary to be stored during power-off are written into the NVRAM 54.

The security ECU 10 uses multiple speakers 1, 2, 3 and 4 mounted in the vehicle as a microphone, and identifies a location of the vehicle to which the impact is applied by using a time difference between back electromotive forces generated in speaker 1, 2, 3 and 4. In speaker 1, 2, 3 and 4, back electromotive force is generated by vibration of a voice coil located in magnetic field caused by the vehicle vibration.

As the impact sound becomes a sonic wave and is carried in the air, the back electromotive force is fastest generated in the speaker which is located nearest to the location to which the impact is applied, and the back electromotive force is last generated in the speaker which is located farthest from the location to which the impact is applied. The difference between arrival times of the impact sound generated by the impact applied to the vehicle at speakers shows up as the difference between generated times of back electromotive forces in speakers.

In the present embodiment, the location of the impact applied to the vehicle is identified by using these characteristics.

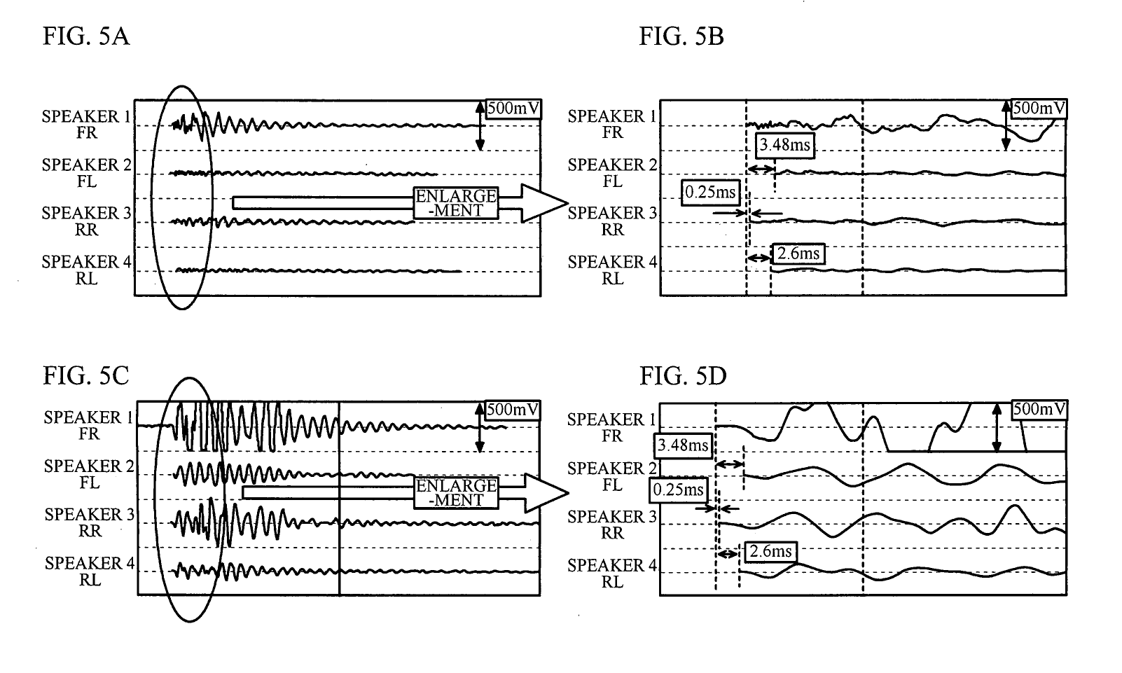

FIG. 5A illustrates back electromotive forces generated in speakers 1, 2, 3 and 4 when the impact is applied to the window glass of the driver's seat 5 with a jig. FIG. 5B enlarges waveforms at the point when back electromotive forces are generated in speakers 1, 2, 3 and 4.

As illustrated in FIG. 5B, the back electromotive force is generated first in the speaker 1 which is nearest to the window glass 60 of the driver's seat 5 to which the impact is applied. The back electromotive force is generated secondarily in the speaker 3 on the right side of the rear seat which is second nearest to the window glass of the driver's seat 5. Then, back electromotive forces are generated in order of the speaker 4 on the left side of the rear seat and the speaker 2 of the passenger seat, according to the distance from the window glass 60 of the driver's seat 5.

FIG. 5C illustrates back electromotive forces generated in speakers 1, 2, 3 and 4 when the impact is applied to the window glass of the driver's seat 5 by hand. FIG. 5D enlarges waveforms at the point when the back electromotive force is generated in each speaker.

In this case, back electromotive forces are generated in order of the speaker 1 of the driver's seat 5, the speaker 3 on the right side of the rear seat, the speaker 4 on the left side of the rear seat and the speaker 2 of the passenger seat, in the same manner as the impact by a jig.

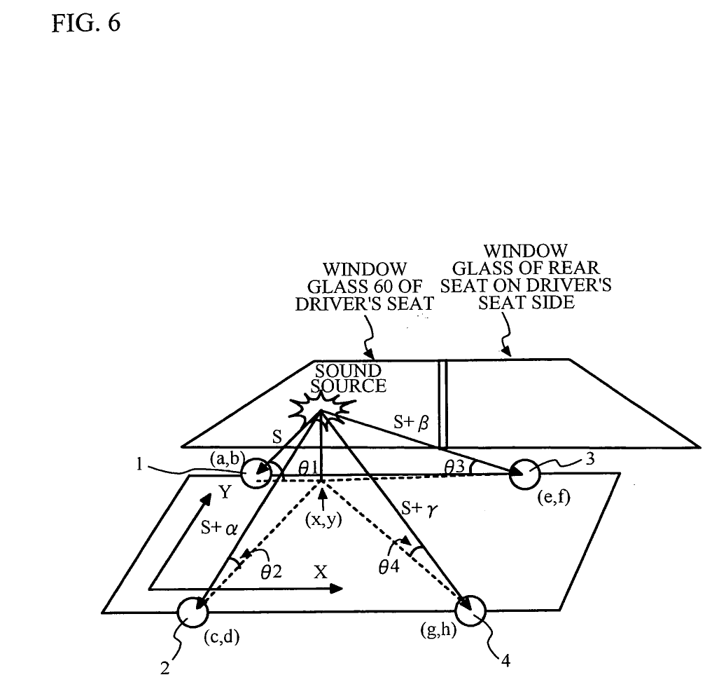

Referring to FIG. 6, a description will be given of a method for identifying a location to which an impact is applied.

A location in a vehicle to which a impact is applied is referred to as a sound source (which corresponds to a generation source of the impact in the present invention) because the impact sound is generated by the impact. A distance (unit: m) between the sound source and the speaker which is nearest to the sound source is defined as S. Distances between the sound source and other speakers can be expressed with a time difference from the generated time of the back electromotive force generated in the nearest speaker.

For example, an impact is applied to the window glass 60 of the driver's seat as illustrated in FIG. 6. In this case, the speaker which is nearest to the sound source is the speaker 1. When a time difference between the time when the back electromotive force is generated in the speaker 1 and the time when the back electromotive force is generated in the speaker 2 is defined as U, the distance (unit: m) between the sound source and the speaker S2 is expressed as S+U (331.5+0.6×t). “t” is a temperature (° C.) of the vehicle interior. When U (331.5+0.6×t) is expressed with α, a distance between the sound source and the speaker S2 is expressed as S+α.

In the same manner, when a time difference between the time when the back electromotive force is generated in the speaker S1 and the time when the back electromotive force is generated in the speaker S3 is defined as V, a distance (unit: m) between the sound source and the speaker S3 is expressed as S+V (331.5+0.6×t). When V (331.5+0.6×t) is expressed with β, the distance between the sound source and the speaker S3 is expressed as S+β.

In the same manner, when a time difference between the time when the back electromotive force is generated in the speaker S1 and the time when the back electromotive force is generated in the speaker S4 is defined as W, a distance (unit: m) between the sound source and the speaker S4 is expressed as S+W (331.5+0.6×t). When W (331.5+0.6×t) is expressed with γ, the distance between the sound source ant the speaker S4 is expressed as S+γ.

Distances on an XY plane where four speakers 1, 2, 3 and 4 exist are calculated by multiplying calculated distances by a correction coefficient. Assume that four speakers 1, 2, 3 and 4 mounted in the vehicle are on the same plane (defined as the XY plane), and define angles (sharp angle) between lines connecting representative point on each window glass to speakers 1, 2, 3 and 4 and the XY plane as θ1, θ2, θ3 and θ4. Distances between the sound source and speakers 1, 2, 3 and 4 on the XY plane are calculated by multiplying distances between the sound source and speakers S, S+α, S+β and S+γ by cos θ1, cos θ2, cos θ3 and cos θ4 respectively. The correction coefficient cos θ is stored in a memory such as RAM 53 in accordance with each window glass. The middle position or barycentric position can be used as the representative point of the window glass.

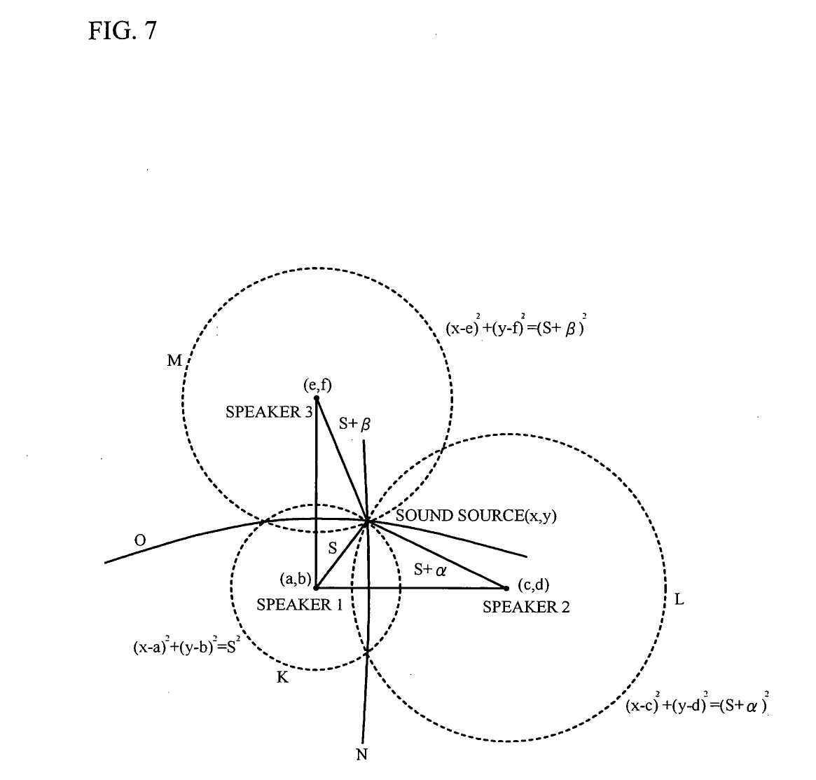

After distances between the sound source and speakers 1, 2, 3 and 4 on the XY plane are calculated, the location of the sound source is identified by calculating an intersection of three circles as illustrated in FIG. 7.

For instance, the equation of a circle K passing through the speaker 1 and the sound source is expressed by following formula (1).

(x−a)²+(y−b)²=S² (1)

The coordinate position of the sound source on the XY plane is defined as (x, y), and the coordinate position of the speaker 1 on the XY plane is defined as (a, b).

In the same manner, the equation of a circle L passing through the speaker 2 and the sound source is expressed by following formula (2).

(x−c)²+(y−d)²=(S+α) (2)

The coordinate position of the speaker 2 on the XY plane is defined as (c, d).

In the same manner, the equation of a circle M passing through the speaker 3 and the sound source is expressed by following formula (3).

(x−e)²+(y−f)²=(S+α)² (3)

The coordinate position of the speaker 2 in the XY plane is defined as (e, f).

As illustrated in FIG. 7, the sound source exists at the position where the locus of the intersection of the circle K with the circle L intersects with the locus of the intersection of the circle K with the circle M.

As the distance between the representative point of each window glass and the XY plane is preliminarily known, it is possible to determine whether the impact sound detected by speakers 1, 2, 3 and 4 is the sound applied to the window glass with good accuracy by calculating the coordinate position of the sound source on the XY plane.

When the identified location of the sound source shows the location far off the vehicle, it is possible to determine that speakers detected the sound generated outside the vehicle, and vibrated.

The location of the impact applied to the vehicle can be determined by using same procedure.

Correction coefficients are prepared in accordance with divided regions of the vehicle, the location of the sound source is identified based on the difference between generated times of back electromotive forces in speakers 1, 2, 3 and 4, and the sound source location on the XY plane where speakers exist is identified.

According to the present embodiment, as the location of the sound source on the plane where speakers 1, 2, 3 and 4 exist is calculated, it is possible to reduce calculation amount and obtain the sound source location easily.

When there is not so much of a difference between generated times of back electromotive forces in speakers 1, 2, 3 and 4, it is possible to determine that the sound generated by the thunder or fire works is detected by speakers.

When speakers 1, 2, 3 and 4 detect the sound of thunder, as there is not so much of a difference between arrival times of the sound wave at speakers 1, 2, 3 and 4, there is not so much of a difference between generated times of back electromotive forces in speakers 1, 2, 3 and 4. Thus, a judgment threshold value (referenced as a first judgment threshold value corresponding to a first threshold value of the present invention) is prepared, and when the difference between generated times of back electromotive forces is less than the first judgment threshold value, it is determined that the vibration is generated by the sound generated outside the vehicle such as thunder or fire works.

In the present embodiment, it is determined whether the impact is applied to the window glass or the vehicle body by using a frequency of the impact sound.

When the window glass of the vehicle is hit by the metal, frequencies of signals of back electromotive forces generated in speakers 1, 2, 3 and 4 are about 500 Hz through 1 KHz. Compared to this, they are less than 100 Hz in the case of the impact to the vehicle body. Therefore, it is possible to determine whether the impact is applied to the window glass or the vehicle body by using frequencies of signals of back electromotive forces generated in speakers 1, 2, 3 and 4. In the present embodiment, a second judgment threshold value is prepared, and it is determined whether frequencies of signals of back electromotive forces generated in speakers 1, 2, 3 and 4 are less than or equal to the second judgment threshold value or not.

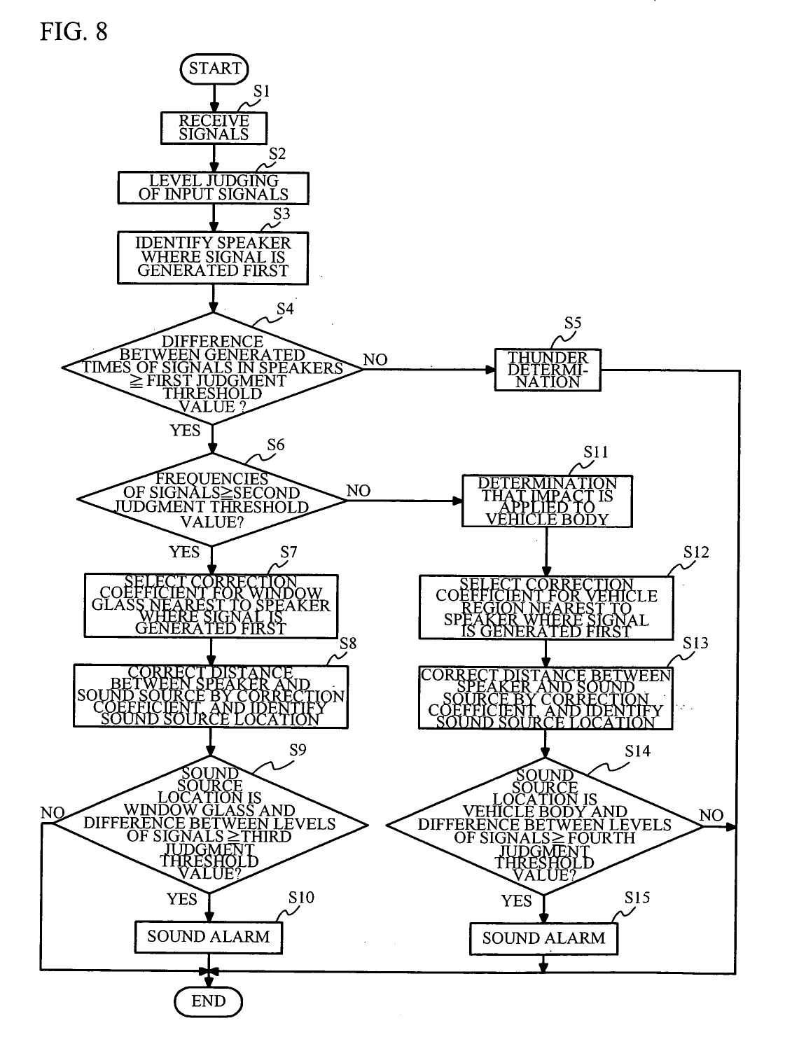

Referring to a flowchart illustrated in FIG. 8, a processing procedure of the security ECU 10 will be described.

The security ECU 10 receives signals of back electromotive forces generated in four speaker 1, 2, 3 and 4 mounted in the vehicle (step S1), and executes a signal processing by signal processing unit 11, 12, 13 and 14. Processes such as filtering, amplification, and AD conversion are executed, and processed signals are input to the main microcomputer 15 of the security ECU 10.

Then, the main microcomputer 15 judges signal levels of input signals (step S2), and identifies the speaker where the signal is generated first (step S3: corresponding to the detection unit identification process of the present invention).

Then, the main microcomputer 15 determines whether differences between generated times of signals in speakers 1, 2, 3 and 4 are greater than or equal to the first judgment threshold value (step S4). When differences between generated times of signals are less than the first judgment threshold value (step S4/NO), the main microcomputer 15 determines that the vibration is generated by the thunder (step S5: corresponding to the thunder determination process of the present invention).

The main microcomputer 15 determines whether frequencies of input signals are greater than or equal to the second judgment threshold value (step S6: corresponding to the impact location estimation process of the present invention). When frequencies of input signals are greater than or equal to the second judgment threshold value (e.g. 500 Hz) (step SUITES), the main microcomputer 15 determines that the impact is applied to the window glass. Then the correction coefficient for the window glass which is nearest to the speaker where the signal is generated first is selected from the memory (step S7: corresponding to the impact location identification process of the present invention). The main microcomputer 15 multiplies the variable representing distances between the sound source and speakers by the correction coefficient, and converts them to distances on the XY plane where speakers exist. The location of the sound source on the XY plane is identified with formulas (1), (2) and (3) (step S8: corresponding to the impact location identification process).

As the distance between the XY plane and the window glass is preliminarily know, the main microcomputer 15 calculates the sound source location from the sound source location on the XY plane. Then, the main microcomputer 15 determines whether the calculated sound source location shows the location of the window glass, and whether the difference between signal levels of signals input from speakers 1, 2, 3 and 4 is greater than or equal to the third judgment threshold value.

When the impact is applied to the window glass, there is a big difference between the signal level of back electromotive force detected by the speaker which is nearest to the window glass to which the impact is applied and signal levels of back electromotive forces detected by other speakers. It is possible to increase the determination accuracy to determine whether the impact is applied to the window glass by judging the difference between signal levels detected by speakers.

When the sound source location is not the window glass (step S9/NO), the alarm sound is not made, and the process is ended. When the difference between signal levels of signals input from speakers is less than the third judgment threshold value (step S9/NO), the alarm sound is not made, and the process is ended.

When the sound source location shows the window glass, and the difference between signal levels of signals input from speakers is greater than or equal to the third judgment threshold value (step S9/YES), it is determined that the impact is applied to the window glass, and the security ECU 10 outputs a predetermined signal to the alarm output unit 16, and turns on switches 17 and 18. Receiving the predetermined signal from the main microcomputer 15, the alarm output unit 16 outputs the alarm sound. This alarm sound is output from speakers 1 and 2 (step S10: corresponding to the alarm control process of the present invention).

When frequencies of input signals are less than the second judgment threshold value (e.g. 500 Hz) in the step S6 (step S6/N0), the main microcomputer 15 determines that the impact is applied to the vehicle body (step S11). Then, the correction coefficient for the vehicle region which is nearest to the speaker where the signal is generated first is selected from the memory (step S12: corresponding to the impact location identification process of the present invention). The main microcomputer 15 multiplies the variable representing distances between the sound source and speakers by the correction coefficient, and converts them to distances on the XY plane where speakers exist. The location of the sound source on the XY plane is identified by using formulas (1), (2) and (3) described above (step S13: corresponding to the impact location identification process).

As the distance between the XY plane and the vehicle region is preliminarily known, the main microcomputer 15 calculates the sound source location from the calculated sound source location on the XY plane. The main microcomputer 15 determines whether the calculated sound source location shows the vehicle region, and whether the difference between signal levels of signals input from speakers 1, 2, 3 and 4 is greater than or equal to the fourth judgment threshold value.

When the impact is applied to the vehicle body, there is a big difference between the signal level of back electromotive force detected by the speaker which is nearest to the vehicle region where the impact is applied and signal levels of back electromotive forces detected by other speakers. It is possible to increase the determination accuracy to determine whether the impact is applied to the vehicle body by judging the difference between signal levels detected by speakers. The fourth judgment threshold is set greater than the third judgment threshold value. This is for sounding the alarm when the enormous impact is applied to the vehicle body.

When the sound source location is not the vehicle region (step S14/N0), the alarm sound is not made, and the process is ended. When the difference between signal levels of signals input from speakers is less than the fourth judgment threshold value (step S14/NO), the alarm sound is not made and the process is ended.

When the sound source location shows the vehicle region, and the difference between signal levels of signals input from speakers is greater than or equal to the fourth judgment threshold value (step S14/YES), it is determined that the impact is applied to the vehicle body, and the security ECU 10 outputs the predetermined signal to the alarm output unit 16, and outputs the alarm sound from speakers 1 and 2 (step S10).

According to the present embodiment, it is possible to identify the sound source location based on the difference between input times of impact sound to the multiple speakers 1 with good accuracy. Therefore, when the impact is applied to the vehicle, it is possible to identify the location where the impact is applied, and increase the accuracy of the vehicular anti-theft.

Although detail descriptions are given of a preferred embodiment of the present invention, the present invention is not limited to the specifically described embodiment and variation, but other embodiments and variations may be made without departing from the scope of the present invention.

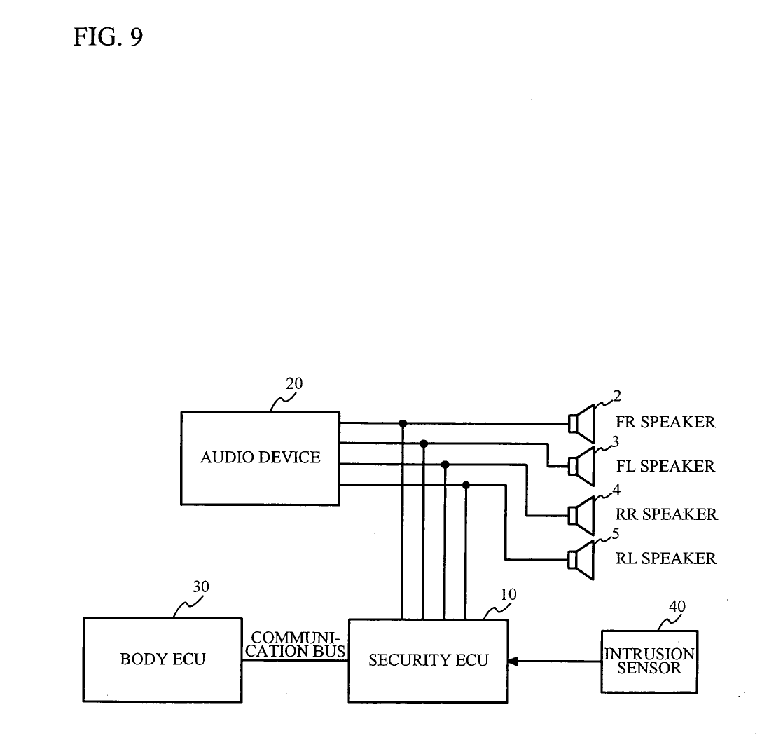

For example, as illustrated in FIG. 9, it is possible to provide an intrusion sensor 40, and put the alarm output unit 16 into operation based on the detection result by the intrusion sensor 40 and the identification result of the generated location of the impact sound using speakers 1, 2, 3 and 4.

In the above embodiment, the alarm output unit 16 is provided and the alarm is output from the speaker. However, it is possible to notify the security center by a radio communication unit.

In the above embodiment, multiple speakers for audio are used as multiple sound input units, but it is possible to provide multiple dedicated microphones. It is desirable to provide more than three (four, more preferably) sound input units because it is desirable that multiple sound input units are spread to back and front and left and right to identify the sound source location with high accuracy.

In the above embodiment, the method for identifying the sound source location by speakers is described, but it may be possible to use other sensors such as a radio wave sensor, a vibration sensor, and a sound sensor.

1. An anti-theft system of a vehicle comprising:
a plurality of detection units that detect an impact applied to the vehicle; and
a control device that executes:
a detection unit identification process for identifying a detection unit that detects the impact first on the basis of values of signals from the plurality of detection units;
an impact location estimation process for estimating that the impact is applied to a window glass when a value of a signal from the identified detection unit is greater than or equal to a predetermined threshold value, and estimating that the impact is applied to a vehicle body when the value of the signal from the identified detection unit is less than the predetermined threshold value; and
an impact location identification process for estimating a distance between the estimated detection unit and a generation source of the impact by a correction coefficient for a case that the estimated impact location is the window glass when the estimated impact location is the window glass, estimating the distance between the estimated detection unit and the generation source of the impact by a correction coefficient for a case that the estimated impact location is the vehicle body when the estimated impact location is the vehicle body, and identifying an impact location from the window glass, the vehicle body, and other locations on the basis of the estimated distance.

2. The anti-theft system according to claim 1, wherein the control device executes a thunder determination process for determining whether the impact applied to the vehicle is caused by a thunder on the basis of the value of the signal from the detection unit.

3. The anti-theft system according to claim 1, wherein the detection unit is one of a speaker, a radio wave sensor, a vibration sensor, and a sound sensor mounted in the vehicle.

4. The anti-theft system according to claim 1, wherein the control device executes an alarm control process for outputting an alarm sound when the impact location is the window glass or the vehicle body.

5. The anti-theft system according to claim 1, wherein the impact location identification process is for defining a distance between the detection unit that detects the impact first among the plurality of detection units that detect the impact applied to the vehicle and the generation source of the impact as a standard distance, and calculating how far away distances between other detection units and the generation source are from the standard distance on the basis of a difference between input times of signals representing the impact from the detection unit that detects the impact first and other detection units.

6. The anti-theft system according to claim 1, wherein the impact location identification process is for identifying the location of the generation source of the impact by converting distances between the plurality of the detection unit that detect the impact applied to the vehicle and the generation source of the impact to distances on a given plane.

7. The anti-theft system according to claim 6, wherein the impact location identification process is for identifying an intersection of circles of which radii are distances between at least three of the detection units and the generation source of the impact on the given plane as the generation source of the impact on the given plane.

8. An anti-theft control method of a vehicle executing:
a detection unit identification step that identifies a detection unit that detects an impact first on the basis of values of signals from a plurality of detection unites that detects the impact applied to the vehicle;
an impact location estimation step that estimates that the impact is applied to a window glass when a value of a signal from the identified detection unit in the detection unit identification step is greater than or equal to a predetermined threshold value, and estimates that the impact is applied to a vehicle body when the value of the signal from the identified detection unit is less than the predetermined threshold value;
an impact location identification step that estimates a distance between the estimated detection unit and a generation source of the impact by a correction coefficient for a case that the estimated impact location is the window glass when the estimated impact location in the impact location estimation step is the window glass, estimates the distance between the estimated detection unit and the generation source of the impact by a correction coefficient for a case that the estimated impact location is the vehicle body when the estimated impact location is the vehicle body, and identifies the impact location from the window glass, the vehicle body, and other locations on the basis of the estimated distance.
